(19) United States
(12) Patent Application Publication
(10) Pub. No.: US 2021/0367256 A1
(43) Pub. Date: Nov. 25, 2021

(54) FLOW BATTERY

(71) Applicant: Panasonic Intellectual Property Management Co., Ltd., Osaka (JP)

(72) Inventors: SHUJI ITO, Nara (JP); MASAHISA FUJIMOTO, Osaka (JP); HONAMI SAKO, Osaka (JP)

(21) Appl. No.: 17/394,405

(22) Filed: Aug. 5, 2021

Related U.S. Application Data
(63) Continuation of application No. PCT/JP2019/041832, filed on Oct. 25, 2019.

(30) Foreign Application Priority Data
May 20, 2019 (JP) 2019-094723

(51) Int. Cl. H01M 8/18; H01M 8/1016; H01M 4/38; H01M 8/04186

(52) U.S. Cl. CPC H01M 8/188; H01M 8/1016; H01M 2004/028; H01M 8/04186; H01M 2300/0065; H01M 4/382

(57) ABSTRACT

A flow battery includes a negative electrode, a positive electrode, a first liquid including first redox species, a second liquid, and a lithium ion conductive membrane. At least one selected from the group consisting of the first liquid and the second liquid includes a supporting electrolyte including lithium. The total of the number of moles of lithium dissolved in the first liquid and the number of moles of lithium dissolved in the second liquid is larger than the number of moles of lithium present in the supporting electrolyte. 0.2≤(M1+M2−M3)/M4≤1.5 wherein M1 is the number of moles of lithium dissolved in the first liquid, M2 is the number of moles of lithium dissolved in the second liquid, M3 is the number of moles of lithium present in the supporting electrolyte, and M4 is the number of moles of the first redox species.

### BACKGROUND

### 1. Technical Field

The present disclosure relates to a flow battery.

### 2. Description of the Related Art

Japanese Patent No. 5417441 discloses a redox flow battery that uses a negative electrode slurry solution including a non-aqueous solvent and metal particles serving as solid negative electrode active material particles.

WO 2016/208123 and US Patent Application No. 2015/0255803 disclose redox flow batteries in which an electrolytic solution is circulated between a solid negative electrode active material and an electrode. The electrolytic solution includes redox species dissolved therein. For example, the electrolytic solution includes a non-aqueous solvent. The electrolytic solution is circulated using, for example, a pump. WO 2018/016249 discloses a flow battery.

### SUMMARY

In the related art, there is a demand for flow batteries having high charge/discharge efficiency.

In one general aspect, the techniques disclosed here feature a flow battery including a negative electrode; a positive electrode; a first liquid in contact with the negative electrode, the first liquid including first redox species that includes an aromatic compound capable of dissolving lithium as a cation; a second liquid in contact with the positive electrode; and a lithium ion conductive membrane disposed between the first liquid and the second liquid, wherein at least one selected from the group consisting of the first liquid and the second liquid includes a supporting electrolyte including lithium, the total of the number of moles of lithium dissolved in the first liquid and the number of moles of lithium dissolved in the second liquid is larger than the number of moles of lithium present in the supporting electrolyte, and the flow battery satisfies 0.2 (M1+M2−M3)/M4≤1.5 wherein M1 is the number of moles of lithium dissolved in the first liquid, M2 is the number of moles of lithium dissolved in the second liquid, M3 is the number of moles of lithium present in the supporting electrolyte, and M4 is the number of moles of the first redox species.

The flow battery according to the present disclosure attains high charge/discharge efficiency.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view illustrating a schematic configuration of a flow battery according to an embodiment;

FIG. 2 is a view illustrating an operation of the flow battery shown in FIG. 1; and

FIG. 3 is a graph illustrating a relationship between the initial charge/discharge efficiency and the value of (M1+M2−M3)/M4 in cells of MEASUREMENT EXAMPLES 1 to 3.

### DETAILED DESCRIPTION

### (Underlying Knowledge Forming Basis of the Present Disclosure)

First redox species including an aromatic compound can dissolve lithium as a cation. The first redox species functions as, for example, a negative electrode mediator in a flow battery. In a flow battery containing such a negative electrode mediator and a positive electrode mediator, the charging voltage of the flow battery is determined by the difference between the charging potential of the positive electrode mediator and the charging potential of the negative electrode mediator. The discharging voltage of the flow battery is determined by the difference between the discharging potential of the positive electrode mediator and the discharging potential of the negative electrode mediator. The charging potential and discharging potential of the above first redox species are relatively low, for example, less than 1.0 V vs. Li/Li⁺. Thus, the charging voltage and discharging voltage of a flow battery may be enhanced by using the first redox species as the negative electrode mediator. That is, the first redox species allows a flow battery to realize a high energy density. Unfortunately, the first redox species may react irreversibly with lithium during charging of the flow battery to form an electrochemically inert compound together with lithium. This reaction is particularly likely to occur during the first cycle of charging. The reaction reduces the amount of lithium used for discharging of the flow battery, resulting in a decrease in the discharge capacity of the flow battery. The decrease in discharge capacity lowers the charge/discharge efficiency.

A flow battery according to a first aspect of the present disclosure includes:

a negative electrode;

a positive electrode;

a first liquid in contact with the negative electrode, the first liquid including first redox species that includes an aromatic compound capable of dissolving lithium as a cation;

a second liquid in contact with the positive electrode; and

a lithium ion conductive membrane disposed between the first liquid and the second liquid, wherein

at least one selected from the group consisting of the first liquid and the second liquid includes a supporting electrolyte including lithium,

the total of the number of moles of lithium dissolved in the first liquid and the number of moles of lithium dissolved in the second liquid is larger than the number of moles of lithium present in the supporting electrolyte, and

the flow battery satisfies 0.2 s (M1+M2−M3)/M4≤1.5 wherein M1 is the number of moles of lithium dissolved in the first liquid, M2 is the number of moles of lithium dissolved in the second liquid, M3 is the number of moles of lithium present in the supporting electrolyte, and M4 is the number of moles of the first redox species.

In the first aspect, the total of the number of moles of lithium dissolved in the first liquid and the number of moles of lithium dissolved in the second liquid is larger than the number of moles of lithium present in the supporting electrolyte. That is, an additional lithium source other than the supporting electrolyte is dissolved in the first liquid or the second liquid. Part of the first redox species forms an electrochemically inert compound beforehand together with lithium present in the additional lithium source. The remaining part of the first redox species scarcely forms an inert compound together with lithium during charging of the flow battery and therefore the discharge capacity of the flow battery is hardly lowered. As a result, the flow battery attains high charge/discharge efficiency.

The flow battery according to the first aspect satisfies 0.2≤(M1+M2−M3)/M4≤1.5 wherein M1 is the number of moles of lithium dissolved in the first liquid, M2 is the number of moles of lithium dissolved in the second liquid, M3 is the number of moles of lithium present in the supporting electrolyte, and M4 is the number of moles of the first redox species. This configuration ensures that high charge/discharge efficiency will be achieved while suppressing the precipitation of solid lithium during charging and discharging of the flow battery.

In a second aspect of the present disclosure, for example, the flow battery according to the first aspect may further include a negative electrode active material in contact with the first liquid, a first container containing the negative electrode active material, and a negative electrode chamber containing the negative electrode, and, in the first container, the first redox species may be oxidized or reduced by the negative electrode active material. According to the second aspect, the first redox species scarcely forms an inert compound together with lithium during charging of the flow battery. Consequently, lithium may be occluded into or released from the negative electrode active material without a decrease in efficiency. Thus, the discharge capacity and charge capacity of the flow battery are not lowered even when the flow battery is charged and discharged at a high current value.

In a third aspect of the present disclosure, for example, the flow battery according to the second aspect may be such that the negative electrode active material includes lithium.

In a fourth aspect of the present disclosure, for example, the flow battery according to the second or third aspect may further include a first circulator that circulates the first liquid between the negative electrode and the negative electrode active material.

In a fifth aspect of the present disclosure, for example, the flow battery according to any one of the first to fourth aspects may further include a positive electrode active material in contact with the second liquid, a second container containing the positive electrode active material, and a positive electrode chamber containing the positive electrode; the second liquid may include second redox species; and, in the second container, the second redox species may be oxidized or reduced by the positive electrode active material.

In a sixth aspect of the present disclosure, for example, the flow battery according to the fifth aspect may be such that the positive electrode active material includes lithium.

In a seventh aspect of the present disclosure, for example, the flow battery according to the fifth or sixth aspect may further include a second circulator that circulates the second liquid between the positive electrode and the positive electrode active material.

In an eighth aspect of the present disclosure, for example, the flow battery according to any one of the first to seventh aspects may be such that the first redox species includes at least one selected from the group consisting of phenanthrene, biphenyl, o-terphenyl, triphenylene, anthracene, acenaphthene, acenaphthylene, fluoranthene, trans-stilbene, benzil and naphthalene.

In a ninth aspect of the present disclosure, for example, the flow battery according to any one of the first to eighth aspects may be such that the supporting electrolyte includes LiPF₆.

In a tenth aspect of the present disclosure, for example, the flow battery according to any one of the first to ninth aspects may be such that the first liquid includes a cyclic ether as a solvent.

In an eleventh aspect of the present disclosure, for example, the flow battery according to the tenth aspect may be such that the cyclic ether includes 2-methyltetrahydrofuran. The flow batteries according to the third to eleventh aspects attain a high energy density.

Embodiments of the present disclosure will be described hereinbelow with reference to the drawings. The scope of the present disclosure is not limited to those embodiments described below.

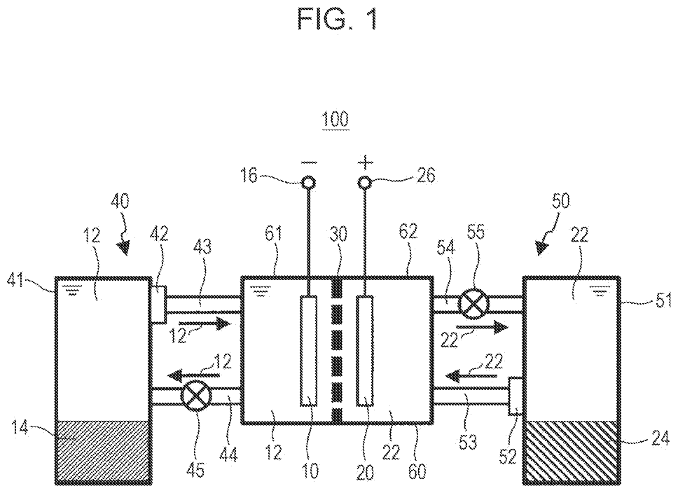

FIG. 1 is a schematic view illustrating a schematic configuration of a flow battery 100 according to an embodiment. As illustrated in FIG. 1, the flow battery 100 includes a negative electrode 10, a positive electrode 20, a first liquid 12, a second liquid 22, and a lithium ion conductive membrane 30. The flow battery 100 may further include a negative electrode active material 14. The first liquid 12 includes a solvent and first redox species. For example, the first liquid 12 is in contact with each of the negative electrode 10 and the negative electrode active material 14. In other words, the negative electrode 10 and the negative electrode active material 14 are each immersed in the first liquid 12. The second liquid 22 includes a solvent. The second liquid 22 is in contact with the positive electrode 20. In other words, the positive electrode 20 is immersed in the second liquid 22. The lithium ion conductive membrane 30 is disposed between the first liquid 12 and the second liquid 22 and separates the first liquid 12 and the second liquid 22 from each other. The lithium ion conductive membrane 30 has lithium ion conductivity.

At least one selected from the group consisting of the first liquid 12 and the second liquid 22 includes a supporting electrolyte containing lithium. The supporting electrolyte is dissolved in at least one selected from the group consisting of the first liquid 12 and the second liquid 22. The supporting electrolyte enhances the ion conductivity in the first liquid 12 and the second liquid 22. For example, the supporting electrolyte includes a lithium salt as a principal component. The term “principal” means that the component represents the highest weight proportion in the supporting electrolyte. The supporting electrolyte may substantially consist of a lithium salt. The phrase “substantially consist of” means that the material mentioned includes no other components that alter the essential characteristics of the material. However, the supporting electrolyte may include impurities in addition to the lithium salt. Examples of the lithium salts include LiPF₆, LiBF₄, LiSbF₆, LiAsF₆, LiSO₃CF₃, LiN(SO₂CF₃)₂, LiN(SO₂C₂F₅)², LiN(SO₂CF₃)(SO₂C₄F₉) and LiC(SO₂CF₃)₃. For example, the supporting electrolyte includes LiPF₆. The supporting electrolyte may consist of LiPF₆.

In the present embodiment, the total of the number of moles M1 of lithium dissolved in the first liquid 12 and the number of moles M2 of lithium dissolved in the second liquid 22 is larger than the number of moles M3 of lithium present in the supporting electrolyte. That is, an additional lithium source other than the supporting electrolyte is dissolved in the first liquid 12 or the second liquid 22. The additional lithium source is, for example, lithium metal. The additional lithium source may form or may not form lithium ions by being dissolved in the first liquid 12 or the second liquid 22. Part of the additional lithium source may be present as microparticles without being dissolved in the first liquid 12 or the second liquid 22.

The number of moles M1 of lithium dissolved in the first liquid 12 may be calculated based on, for example, the molar concentration of lithium in the first liquid 12 and the volume of the first liquid 12. Similarly, the number of moles M2 of lithium dissolved in the second liquid 22 may be calculated based on, for example, the molar concentration of lithium in the second liquid 22 and the volume of the second liquid 22. The molar concentration of lithium in the first liquid 12 and the molar concentration of lithium in the second liquid 22 may be measured by, for example, inductively coupled plasma (ICP) emission spectrometry. The number of moles M1 and the number of moles M2 each vary depending on whether the flow battery 100 is charged or discharged. However, the total of the number of moles M1 and the number of moles M2 hardly changes during charging and discharging of the flow battery 100.

For example, the number of moles M3 of lithium present in the supporting electrolyte may be determined in the following manner. First, the molar concentration of the anionic species contained in the lithium salt is measured with respect to each of the first liquid 12 and the second liquid 22. For example, the molar concentration of the anionic species may be measured by inductively coupled plasma (ICP) emission spectrometry. Based on the molar concentration of the anionic species and the valence of the anionic species, the molar concentration of the lithium salt is calculated with respect to each of the first liquid 12 and the second liquid 22. When, for example, LiPF₆ is used as the lithium salt, the molar concentration of phosphorus may be measured with respect to each of the first liquid 12 and the second liquid 22, and the values obtained by the measurement may be regarded as the molar concentrations of the lithium salt. Based on the molar concentration of the lithium salt in the first liquid 12, the number of moles of lithium contained in 1 mol of the lithium salt, and the volume of the first liquid 12, the number of moles A of lithium derived from the supporting electrolyte present in the first liquid 12 is calculated. Based on the molar concentration of the lithium salt in the second liquid 22, the number of moles of lithium contained in 1 mol of the lithium salt, and the volume of the second liquid 22, the number of moles B of lithium derived from the supporting electrolyte present in the second liquid 22 is calculated. The total of the number of moles A and the number of moles B may be regarded as the number of moles M3 of lithium present in the supporting electrolyte.

The total of the number of moles M1 of lithium dissolved in the first liquid 12 and the number of moles M2 of lithium dissolved in the second liquid 22 may be regarded as the total of the number of moles M3 of lithium present in the supporting electrolyte and the number of moles M5 of lithium contained in the additional lithium source other than the supporting electrolyte. Therefore, the number of moles M5 may be calculated from the following equation.

M5=M1+M2−M3

Letting M4 be the number of moles of the first redox species, M1, M2, M3 and M4 satisfy, for example, 0.2≤(M1+M2−M3)/M4≤1.5. From the point of view of enhancing the charge/discharge efficiency, the value of (M1+M2−M3)/M4 may be greater than or equal to 0.25 or may be greater than or equal to 0.28. To suppress the precipitation of solid lithium during charging and discharging of the flow battery 100, the value of (M1+M2−M3)/M4 may be less than or equal to 1.0, may be less than or equal to 0.6, may be less than or equal to 0.4, or may be less than or equal to 0.3. The number of moles M4 of the first redox species may be calculated based on the molar concentration of the first redox species in the first liquid 12 and the volume of the first liquid 12.

The first redox species includes an aromatic compound capable of dissolving lithium as a cation. This aromatic compound may be a condensed aromatic compound. For example, the first redox species includes at least one selected from the group consisting of phenanthrene, biphenyl, o-terphenyl, triphenylene, anthracene, acenaphthene, acenaphthylene, fluoranthene, trans-stilbene, benzil and naphthalene.

In a potential measurement test, the first redox species may have an equilibrium potential of less than 0.3 V vs. Li/Li⁺. For example, the potential measurement test is performed in the following manner. First, a 2-methyltetrahydrofuran solution containing the first redox species at a concentration of 0.1 mol/L is provided. Next, a 2×2 cm copper foil is wrapped with a polypropylene microporous separator. Next, the whole of the separator is wrapped with a large amount of lithium metal foil. Next, a tab is attached to each of the copper foil and the lithium metal foil. Next, the copper foil and the lithium metal foil are wrapped with a laminated exterior, and the 2-methyltetrahydrofuran solution is poured into the inside of the laminated exterior. Immediately after the 2-methyltetrahydrofuran solution is poured, the laminated exterior is sealed by thermal fusion bonding. A potential measurement cell is thus obtained. In the potential measurement cell, the lithium metal foil is in contact with the 2-methyltetrahydrofuran solution, and the lithium metal is dissolved in the 2-methyltetrahydrofuran solution. Here, an excessive amount of the lithium metal is dissolved in the 2-methyltetrahydrofuran solution and consequently the 2-methyltetrahydrofuran solution is saturated with lithium. As an example, the 2-methyltetrahydrofuran solution is saturated with lithium 100 hours after the lithium metal foil comes into contact with the 2-methyltetrahydrofuran solution. Next, the potential versus lithium is measured with respect to the 2-methyltetrahydrofuran solution using the copper foil and the lithium metal foil of the potential measurement cell. The value obtained by the measurement may be regarded as the equilibrium potential of the first redox species. Incidentally, the value measured depends on the type of the first redox species.

When analyzed by the above potential measurement test, the equilibrium potential of the first redox species may be less than or equal to 0.16 V vs. Li/Li⁺, may be less than or equal to 0.1 V vs. Li/Li⁺, may be less than or equal to 0.05 V vs. Li/Li⁺, and may be less than or equal to 0.02 V vs. Li/Li⁺. The lower limit of the equilibrium potential of the first redox species measured by the potential measurement test is not particularly limited and may be 0 V vs. Li/Li⁺.

Examples of the first redox species showing an equilibrium potential of less than 0.3 V vs. Li/Li⁺ in the potential measurement test include phenanthrene, biphenyl, o-terphenyl, triphenylene, anthracene, acenaphthene, acenaphthylene, fluoranthene, benzil and naphthalene. Tables 1 and 2 describe the equilibrium potentials of these first redox species measured by the above potential measurement test.

TABLE 1

| | | Equilibrium potentials |
|---|---|---|
| Names of compounds | Structural formulae | (V vs. Li/Li⁺) |
| Phenanthrene | 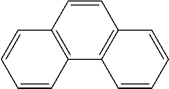 [SMILES: c1ccc2c(c1)ccc1ccccc12] | 0.017 |
| Biphenyl | 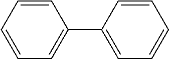 [SMILES: c1ccc(-c2ccccc2)cc1] | 0 |
| o-Terphenyl | 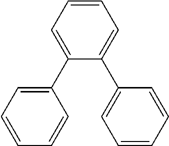 [SMILES: c1ccc(-c2ccccc2-c2ccccc2)cc1] | 0.0006 |
| Triphenylene | 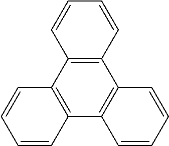 [SMILES: c1ccc2c(c1)c1ccccc1c1ccccc21] | 0.01 |
| Anthracene | 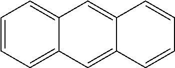 [SMILES: c1ccc2cc3ccccc3cc2c1] | 0.05 |

TABLE 2

| Names | | Equilibrium potentials |
|---|---|---|
| of compounds | Structural formulae | (V vs. Li/Li⁺) |
| Acenaphthene | 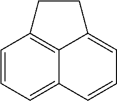 [SMILES: c1cc2c3c(cccc3c1)CC2] | 0.016 |
| Acenaphthylene | 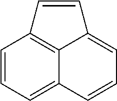 [SMILES: C1=Cc2cccc3cccc1c23] | 0.014 |
| Fluoranthene | 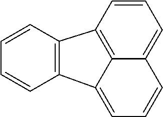 [SMILES: c1ccc2c(c1)-c1cccc3cccc-2c13] | 0.014 |
| Benzil | 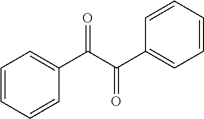 [SMILES: O=C(C(=O)c1ccccc1)c1ccccc1] | 0.16 |
| Naphthalene | 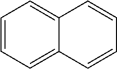 | 0.016 |

The first redox species is oxidized or reduced by the negative electrode 10, and is oxidized or reduced by the negative electrode active material 14. In other words, the first redox species functions as a negative electrode mediator. When the flow battery 100 does not include the negative electrode active material 14, the first redox species functions as an active material that is oxidized or reduced only by the negative electrode 10.

For example, the first redox species is dissolved in the solvent of the first liquid 12. The concentration of the first redox species in the first liquid 12 may be greater than or equal to 0.001 mol/L, may be greater than or equal to 0.01 mol/L, or may be greater than or equal to 0.05 mol/L. The higher the concentration of the first redox species in the first liquid 12, the more the battery capacity of the flow battery 100 is increased. When the flow battery 100 includes the negative electrode active material 14, the occlusion or release of lithium by the negative electrode active material 14 is promoted with increasing concentration of the first redox species in the first liquid 12. From the points of view of the viscosity of the first liquid 12 and the fluidity of the first liquid 12, the concentration of the first redox species in the first liquid 12 may be less than or equal to 2 mol/L, or may be less than or equal to 1 mol/L.

The solvent of the first liquid 12 is capable of dissolving the first redox species as well as lithium. The solvent of the first liquid 12 is, for example, a non-aqueous solvent. For example, the first liquid 12 includes an ether as a solvent. The first liquid 12 may include, as a solvent, an ether that is not co-inserted between layers of graphite together with lithium cations. Examples of the ethers include cyclic ethers and glycol ethers. The glycol ethers may be glymes represented by the compositional formula CH₃(OCH₂CH₂)ₙOCH₃. In the compositional formula, n is an integer of 1 or greater. The ether may include at least one selected from the group consisting of cyclic ethers and glymes. In other words, the first liquid 12 may include, as a solvent, a cyclic ether, a glyme, or a mixture of a cyclic ether and a glyme. For example, the first liquid 12 includes a cyclic ether as a solvent. The solvent of the first liquid 12 may consist of a cyclic ether.

For example, the cyclic ether includes at least one selected from the group consisting of tetrahydrofuran (THF), 2-methyltetrahydrofuran (2MeTHF), 1,3-dioxolane (1,3DO) and 4-methyl-1,3-dioxolane (4Me1,3DO). For example, the cyclic ether includes 2-methyltetrahydrofuran. The cyclic ether may consist of 2-methyltetrahydrofuran.

For example, the glyme includes at least one selected from the group consisting of diglyme (diethylene glycol dimethyl ether), triglyme (triethylene glycol dimethyl ether), tetraglyme (tetraethylene glycol dimethyl ether), pentaethylene glycol dimethyl ether and polyethylene glycol dimethyl ether. The glyme may be a mixture of tetraglyme and pentaethylene glycol dimethyl ether.

The potential of the first liquid 12 may vary depending on the type of the solvent contained in the first liquid 12. When the solvent of the first liquid 12 includes a cyclic ether and when the cyclic ether used is THF or 2MeTHF, the potential of the first liquid 12 tends to be lower. When the solvent of the first liquid 12 includes a glyme and when the glyme used is triglyme, the potential of the first liquid 12 is most lowered. Thus, the solvent of the first liquid 12 may be THF, 2MeTHF or triglyme. Cyclic ethers have a low boiling point and volatilize easily. In view of this, the first liquid 12 may include a mixture of a cyclic ether and a glyme having a relatively high boiling point. That is, the first liquid 12 may include a mixture of THF or 2MeTHF, and triglyme.

When lithium is added to the first liquid 12 containing an aromatic compound as the first redox species, the first redox species receives electrons from lithium. By releasing electrons, lithium changes to lithium cations and is dissolved into the first liquid 12. That is, the first liquid 12 causes lithium to release electrons and thereby causes lithium to be dissolved as cations. In the first redox species that has received electrons from lithium, the first redox species and the electrons are solvated. As a result, the first redox species is dissolved into the first liquid 12. The first redox species having the solvated electrons behaves as anions. In this manner, the first liquid 12 exhibits ion conductivity. Here, the first liquid 12 contains electrons quantitatively equivalent to the lithium cations. Thus, the first liquid 12 has a strong reducing power and a low potential. The first liquid 12 does not have electron conductivity and thus can function as an electrolytic solution.

The negative electrode 10 has a surface that acts as, for example, a reaction field for the first redox species. The material of the negative electrode 10 is stable to, for example, the first liquid 12. The material of the negative electrode 10 is also stable to, for example, electrochemical reaction. Examples of the materials of the negative electrode 10 include metals and carbon. Examples of the metals used as the materials of the negative electrode 10 include stainless steel, iron, copper and nickel. The material of the negative electrode 10 is, for example, stainless steel.

The negative electrode 10 may have a structure having an increased surface area. Examples of the structures having an increased surface area include meshes, nonwoven fabrics, surface-roughened plates and sintered porous bodies. When the negative electrode 10 has such a structure, the oxidation reaction and reduction reaction of the first redox species proceed easily on the negative electrode 10.

The negative electrode active material 14 is capable of occluding or releasing lithium. For example, the negative electrode active material 14 contains lithium occluded therein. The negative electrode active material 14 may have a layered structure. The negative electrode active material 14 may include a metal. For example, the negative electrode active material 14 reacts with lithium during charging of the flow battery 100, forming a lithium compound. When the negative electrode active material 14 has a layered structure, such a lithium compound is, for example, an intercalation compound that has lithium intercalated between the layers of the negative electrode active material 14. When the negative electrode active material 14 includes a metal, the lithium compound is, for example, an alloy containing lithium. The negative electrode active material 14 is insoluble in, for example, the first liquid 12. Therefore, the number of moles of lithium contained in the negative electrode active material 14 is not included in the number of moles M1 of lithium dissolved in the first liquid 12. For example, the negative electrode active material 14 includes at least one selected from the group consisting of graphite, aluminum, tin and silicon. The negative electrode active material 14 may include bismuth or indium. The negative electrode active material 14 allows the flow battery 100 to attain a high energy density.

The negative electrode active material 14 may have any shape without limitation, and may be in the form of particles, powder or pellets. The negative electrode active material 14 may be bound with a binder. Examples of the binders include resins such as polyvinylidene fluoride, polypropylene, polyethylene and polyimide.

The second liquid 22 is, for example, a non-aqueous electrolytic solution. For example, the second liquid 22 includes a non-aqueous solvent. Examples of the non-aqueous solvents include cyclic and chain carbonates, cyclic and chain esters, cyclic and chain ethers, nitriles, cyclic and chain sulfones, and cyclic and chain sulfoxides. The non-aqueous solvent contained in the second liquid 22 may be the same as or different from the solvent present in the first liquid 12.

The second liquid 22 may further include second redox species. In this case, the flow battery 100 may further include a positive electrode active material 24 in contact with the second liquid 22. When the flow battery 100 includes the positive electrode active material 24, the second redox species functions as a positive electrode mediator. The capacity density of a flow battery is determined by “positive electrode capacity density×negative electrode capacity density/(positive electrode capacity density+negative electrode capacity density)”. Therefore, the capacity density of the flow battery 100 may be significantly enhanced by adopting a mediator type flow battery structure not only on the negative electrode 10 side of the flow battery 100 but also on the positive electrode 20 side. The second redox species is dissolved in, for example, the second liquid 22. The second redox species is oxidized or reduced by the positive electrode 20, and is oxidized or reduced by the positive electrode active material 24. When the flow battery 100 does not include the positive electrode active material 24, the second redox species functions as an active material that is oxidized or reduced only by the positive electrode 20. The second redox species may include a single kind of redox species having a plurality of redox potentials, or may include a plurality of kinds of redox species having a single redox potential. The second redox species may be an organic compound having two or more redox potentials. Such an organic compound has, for example, a n-conjugated electron cloud. Examples of the organic compounds having a n-conjugated electron cloud include tetrathiafulvalene derivatives, quinone derivatives and TCNQ. For example, the second redox species is tetrathiafulvalene. When the second redox species is an organic compound, the second redox species may be easily dissolved into the second liquid 22.

The second redox species may be metal-containing ions. Examples of the metal-containing ions include vanadium ions, manganese ions and molybdenum ions. These metal-containing ions have multistages of redox potentials. For example, vanadium ions have multiple reaction stages where the valence changes from divalent to trivalent, trivalent to tetravalent, and tetravalent to pentavalent.

The positive electrode 20 has a surface that acts as, for example, a reaction field for the second redox species. The material of the positive electrode 20 is stable to, for example, the solvent and the supporting electrolyte contained in the second liquid 22. The material of the positive electrode 20 may be insoluble in the second liquid 22. The material of the positive electrode 20 is also stable to, for example, electrochemical reaction. Examples of the materials of the positive electrode 20 include metals and carbon. Examples of the metals used as the materials of the positive electrode 20 include stainless steel, iron, copper and nickel. The material of the positive electrode 20 is, for example, stainless steel. The material of the positive electrode 20 may be the same as or different from the material of the negative electrode 10.

The positive electrode 20 may have a structure having an increased surface area. Examples of the structures having an increased surface area include meshes, nonwoven fabrics, surface-roughened plates and sintered porous bodies. When the positive electrode 20 has such a structure, the oxidation reaction and reduction reaction of the second redox species proceed easily on the positive electrode 20.

When the second liquid 22 does not include the second redox species, the positive electrode 20 may include a current collector and an active material disposed on the current collector. For example, the current collector is made of any of the materials described above as the materials of the positive electrode 20. For example, the active material contained in the positive electrode 20 includes any of the materials of the positive electrode active material 24 described later. The positive electrode 20 may be lithium metal.

When the second liquid 22 includes the second redox species, as described hereinabove, the flow battery 100 may further include the positive electrode active material 24. The positive electrode active material 24 is immersed in the second liquid 22. The positive electrode active material 24 is capable of occluding or releasing lithium. For example, the positive electrode active material 24 contains lithium occluded therein. For example, the positive electrode active material 24 is insoluble in the second liquid 22. Thus, the number of moles of lithium contained in the positive electrode active material 24 is not included in the number of moles M2 of lithium dissolved in the second liquid 22. The positive electrode active material 24 may be an active material used in secondary batteries. Examples of the positive electrode active material 24 include transition metal oxides, fluorides, polyanions, fluorinated polyanions and transition metal sulfides.

The positive electrode active material 24 may include, for example, a compound containing iron, manganese or lithium, a compound containing titanium, niobium or lithium, or a compound containing vanadium. Examples of the compounds containing iron, manganese or lithium include LiFePO₄ and LiMnO₂. Examples of the compounds containing titanium, niobium or lithium include Li₄Ti₅O₁₂ and LiNbO₃. Examples of the compounds containing vanadium include V₂O₅. For example, the positive electrode active material 24 includes lithium iron phosphate (LiFePO₄).

For example, the compounds containing iron, manganese or lithium, and the compounds containing vanadium have a redox potential in the range of 3.2 V to 3.7 V versus lithium. When the positive electrode active material 24 includes any of these compounds, the second redox species may be tetrathiafulvalene. In this case, the flow battery 100 has a high battery voltage. Tetrathiafulvalene has two relatively high redox potentials. The lower limit and upper limit of the redox potentials of tetrathiafulvalene are about 3.4 V and about 3.7 V, respectively, versus lithium.

For example, the compounds containing titanium, niobium or lithium have a redox potential in the range of 1 V to 3 V versus lithium. When the positive electrode active material 24 includes a compound containing titanium, niobium or lithium, the second redox species may be a quinone derivative. For example, a quinone derivative has multiple redox potentials in the range of 1 V to 3 V versus lithium.

The range of potentials at which the positive electrode active material 24 is oxidized and reduced overlaps with, for example, the range of potentials at which the second redox species is oxidized and reduced. For example, the upper limit of the range of potentials at which the second redox species is oxidized and reduced is higher than the upper limit of the range of potentials at which the positive electrode active material 24 is oxidized and reduced. For example, the lower limit of the range of potentials at which the second redox species is oxidized and reduced is lower than the lower limit of the range of potentials at which the positive electrode active material 24 is oxidized and reduced. With this configuration, the capacity of the positive electrode active material 24 may be fully utilized. For example, nearly 100% of the capacity of the positive electrode active material 24 may be used.

The positive electrode active material 24 may further include a conductive auxiliary or an ion conductor. Examples of the conductive auxiliaries include carbon blacks and polyanilines. Examples of the ion conductors include polymethyl methacrylate and polyethylene oxide.

The positive electrode active material 24 may have any shape without limitation, and may be in the form of particles, powder, pellets or film. The positive electrode active material 24 in the form of film may be fixed on a metal foil. The positive electrode active material 24 may be bound with a binder. Examples of the binders include resins such as polyvinylidene fluoride, polypropylene, polyethylene and polyimide. For example, the positive electrode active material 24 is insoluble in the second liquid 22.

The lithium ion conductive membrane 30 electrically separates the negative electrode 10 and the positive electrode 20 from each other. Examples of the lithium ion conductive membrane 30 include porous membranes, ion exchange resin membranes and solid electrolyte membranes. Examples of the porous membranes include glass paper formed by weaving glass fibers into nonwoven fabrics. Examples of the ion exchange resin membranes include cation exchange membranes and anion exchange membranes.

The flow battery 100 may further include an electrochemical reactor 60, a negative electrode terminal 16, and a positive electrode terminal 26.

The electrochemical reactor 60 is divided by the lithium ion conductive membrane 30 into a negative electrode chamber 61 and a positive electrode chamber 62.

The negative electrode 10 is arranged in the negative electrode chamber 61.

The negative electrode terminal 16 is connected to the negative electrode 10.

The positive electrode 20 is arranged in the positive electrode chamber 62.

The positive electrode terminal 26 is connected to the positive electrode 20.

For example, the negative electrode terminal 16 and the positive electrode terminal 26 are connected to a charging/discharging device. The charging/discharging device applies a voltage between the negative electrode terminal 16 and the positive electrode terminal 26, or takes electric power from between the negative electrode terminal 16 and the positive electrode terminal 26.

The flow battery 100 may further include a first circulator 40 and a second circulator 50.

The first circulator 40 is a mechanism that circulates the first liquid 12 between the negative electrode 10 and the negative electrode active material 14.

The first circulator 40 may include a pipe 43, a pipe 44, and a pump 45. To distinguish the pipes, the pipe 43 and the pipe 44 may be referred to as a first pipe and a second pipe, respectively.

The first circulator 40 further includes a first container 41. The first container 41 contains the negative electrode active material 14 in the inside thereof.

Part of the first liquid 12 is accommodated in the first container 41. Further, part of the first liquid 12 is accommodated in the negative electrode chamber 61. At least part of the negative electrode 10 is in contact with the first liquid 12 in the negative electrode chamber 61.

One end of the pipe 43 is connected to an outlet of the first container 41 for the first liquid 12 to flow out.

For example, the pump 45 is provided on the pipe 44. The pump 45 may be provided on the pipe 43.

The first circulator 40 may include a first filter 42.

The first filter 42 blocks the passage of the negative electrode active material 14.

The first filter 42 is provided on the route through which the first liquid 12 flows out from the first container 41 into the negative electrode chamber 61. In FIG. 1, the first filter 42 is provided on the pipe 43.

The second circulator 50 is a mechanism that circulates the second liquid 22 between the positive electrode 20 and the positive electrode active material 24.

The second circulator 50 may include a pipe 53, a pipe 54, and a pump 55. To distinguish the pipes, the pipe 53 and the pipe 54 may be referred to as a first pipe and a second pipe, respectively.

The second circulator 50 further includes a second container 51. The second container 51 contains the positive electrode active material 24 in the inside thereof.

Part of the second liquid 22 is accommodated in the second container 51. Part of the second liquid 22 is accommodated in the positive electrode chamber 62. At least part of the positive electrode 20 is in contact with the second liquid 22 in the positive electrode chamber 62.

One end of the pipe 53 is connected to an outlet of the second container 51 for the second liquid 22 to flow out.

For example, the pump 55 is provided on the pipe 54. The pump 55 may be provided on the pipe 53.

The second circulator 50 may include a second filter 52.

The second filter 52 blocks the passage of the positive electrode active material 24.

The second filter 52 is provided on the route through which the second liquid 22 flows out from the second container 51 into the positive electrode chamber 62. In FIG. 1, the second filter 52 is provided on the pipe 53.

Next, a method for manufacturing the flow battery 100 will be described.

First, a first liquid 12, which includes first redox species and a supporting electrolyte, is provided. Next, an additional lithium source other than the supporting electrolyte is dissolved into the first liquid 12. Here, part of the first redox species forms an electrochemically inert compound together with lithium contained in the additional lithium source. When the ratio of the inert compound relative to the first redox species reaches a certain value, new inert compound is barely formed from the remaining part of the first redox species. Next, the first liquid 12 is added to a negative electrode chamber 61 and a first container 41. A negative electrode 10 is arranged into the negative electrode chamber 61. A negative electrode active material 14 is arranged into the first container 41.

Next, a second liquid 22 including second redox species is provided. The second liquid 22 is added to a positive electrode chamber 62 and a second container 51. A positive electrode 20 is arranged into the positive electrode chamber 62. A positive electrode active material 24 is arranged into the second container 51. Thus, a flow battery 100 is obtained.

The production of the flow battery 100 is not limited to the above method. For example, a supporting electrolyte may be added not only to the first liquid 12 but also to the second liquid 22, or may be added only to the second liquid 22.

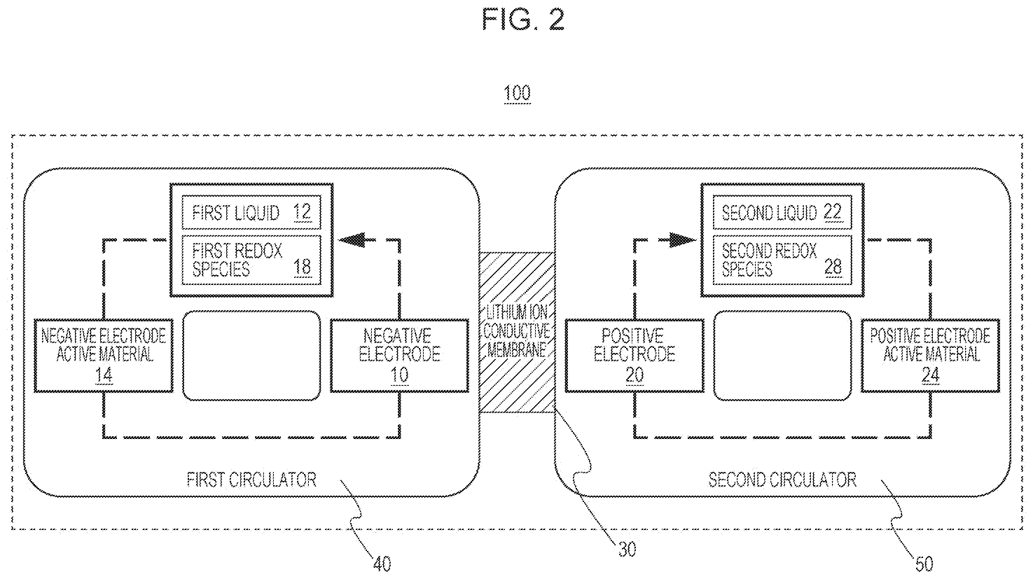

Next, an example of the operation of the flow battery 100 will be described with reference to FIG. 2. FIG. 2 is a view illustrating an operation of the flow battery 100 shown in FIG. 1. In the following description, first redox species 18 may be referred to as “Md”, and the negative electrode active material 14 may be referred to as “NA”. In the following description, tetrathiafulvalene (hereinafter, also referred to as “TTF”) is used as second redox species 28. Lithium iron phosphate (LiFePO₄) is used as the positive electrode active material 24.

### [Flow Battery Charging Process]

First, the flow battery 100 is charged by applying a voltage to the negative electrode 10 and the positive electrode 20 of the flow battery 100. In the following, the reactions on the negative electrode 10 side and the reactions on the positive electrode 20 side in the charging process will be described.

### (Reactions on the Negative Electrode Side)

By the application of a voltage, electrons are supplied from the outside of the flow battery 100 to the negative electrode 10. As a result, the first redox species 18 is reduced on the surface of the negative electrode 10. For example, the reduction reaction of the first redox species 18 is represented by the following reaction formula. The lithium ions (Li⁺) are supplied from, for example, the second liquid 22 through the lithium ion conductive membrane 30.

Md+Li⁺e⁻→Md.Li

In the above reaction formula, Md.Li is a complex formed between the lithium cation and the reduced first redox species 18. The reduced first redox species 18 has an electron solvated by the solvent of the first liquid 12. As the reduction reaction of the first redox species 18 proceeds, the concentration of Md.Li in the first liquid 12 increases. The potential of the first liquid 12 decreases with increasing concentration of Md.Li in the first liquid 12. The potential of the first liquid 12 decreases below the upper limit potential up to which the negative electrode active material 14 and lithium form a lithium compound.

Next, Md.Li is caused to move to the negative electrode active material 14 by the first circulator 40. The potential of the first liquid 12 is now lower than the upper limit potential up to which the negative electrode active material 14 and lithium form a lithium compound. Thus, the negative electrode active material 14 receives lithium cations and electrons from Md.Li. As a result, the first redox species 18 is oxidized and the negative electrode active material 14 is reduced. For example, these reactions are represented by the following reaction formula. In the reaction formula below, s and t are integers of 1 or greater.

sNA+tMd.Li→NAₛLiₜ+tMd

In the above reaction formula, NAₛLiₜ is a lithium compound formed from the negative electrode active material 14 and lithium. When the negative electrode active material 14 includes graphite, for example, s is 6 and t is 1 in the above reaction formula. In that case, NAₛLiₜ is C₆Li. When the negative electrode active material 14 includes aluminum, tin or silicon, for example, s is 1 and t is 1 in the above reaction formula. In that case, NAₛLiₜ is LiAl, LiSn or LiSi.

Next, the first redox species 18 oxidized by the negative electrode active material 14 is caused to move to the negative electrode 10 by the first circulator 40. The first redox species 18 that has arrived at the negative electrode 10 is reduced again on the surface of the negative electrode 10, thereby forming Md.Li. In the manner described above, the negative electrode active material 14 is charged by the circulation of the first redox species 18. That is, the first redox species 18 functions as a charging mediator.

### (Reactions on the Positive Electrode Side)

By the application of a voltage, the second redox species 28 is oxidized on the surface of the positive electrode 20. As a result, electrons are taken out from the positive electrode 20 to the outside of the flow battery 100. For example, the oxidation reaction of the second redox species 28 is represented by the following reaction formulas.

TTF→TTF⁺+e⁻

TTF⁺→TTF²⁺+e⁻

Next, the second redox species 28 oxidized at the positive electrode 20 is caused to move to the positive electrode active material 24 by the second circulator 50. The second redox species 28 that has arrived at the positive electrode active material 24 is reduced by the positive electrode active material 24. On the other hand, the positive electrode active material 24 is oxidized by the second redox species 28. The positive electrode active material 24 oxidized by the second redox species 28 releases lithium. For example, these reactions are represented by the following reaction formula.

LiFePO₄+TTF²⁺→FePO₄+Li⁺TTF⁺

Next, the second redox species 28 reduced by the positive electrode active material 24 is caused to move to the positive electrode 20 by the second circulator 50. The second redox species 28 that has arrived at the positive electrode 20 is oxidized again on the surface of the positive electrode 20. For example, this reaction is represented by the following reaction formula.

TTF⁺→TTF²⁺+e⁻

In the manner described above, the positive electrode active material 24 is charged by the circulation of the second redox species 28. That is, the second redox species 28 functions as a charging mediator. For example, the lithium ions (Li⁺) generated by charging of the flow battery 100 move to the first liquid 12 through the lithium ion conductive membrane 30.

### [Flow Battery Discharging Process]

In the charged flow battery 100, electric power can be taken out from the negative electrode 10 and the positive electrode 20. In the following, the reactions on the negative electrode 10 side and the reactions on the positive electrode 20 side in the discharging process will be described.

### (Reactions on the Negative Electrode Side)

By discharging of the flow battery 100, the first redox species 18 is oxidized on the surface of the negative electrode 10. As a result, electrons are taken out from the negative electrode 10 to the outside of the flow battery 100. For example, the oxidation reaction of the first redox species 18 is represented by the following reaction formula.

Md.Li→Md+Li⁺+e⁻

The concentration of Md.Li in the first liquid 12 decreases with the progress of the oxidation reaction of the first redox species 18. The potential of the first liquid 12 increases with decreasing concentration of Md.Li in the first liquid 12. As a result, the potential of the first liquid 12 exceeds the equilibrium potential of NAₛLiₜ.

Next, the first redox species 18 oxidized at the negative electrode 10 is caused to move to the negative electrode active material 14 by the first circulator 40. When the potential of the first liquid 12 has exceeded the equilibrium potential of NAₛLₜ, the first redox species 18 receives lithium cations and electrons from NAₛLiₜ. As a result, the first redox species 18 is reduced and the negative electrode active material 14 is oxidized. For example, these reactions are represented by the following reaction formula. In the reaction formula below, s and t are integers of 1 or greater.

NAₛLiₜ+tMd→sNA+tMd.Li

Next, Md.Li is caused to move to the negative electrode 10 by the first circulator 40. Md.Li that has arrived at the negative electrode 10 is oxidized again on the surface of the negative electrode 10. In the manner described above, the negative electrode active material 14 is discharged by the circulation of the first redox species 18. That is, the first redox species 18 functions as a discharging mediator. For example, the lithium ions (Li⁺) generated by discharging of the flow battery 100 move to the second liquid 22 through the lithium ion conductive membrane 30.

### (Reactions on the Positive Electrode Side)

By discharging of the flow battery 100, electrons are supplied from the outside of the flow battery 100 to the positive electrode 20. As a result, the second redox species 28 is reduced on the surface of the positive electrode 20. For example, the reduction reaction of the second redox species 28 is represented by the following reaction formulas.

TTF²⁺+e⁻→TTF⁺

TTF⁺+e⁻→TTF

Next, the second redox species 28 reduced at the positive electrode 20 is caused to move to the positive electrode active material 24 by the second circulator 50. The second redox species 28 that has arrived at the positive electrode active material 24 is oxidized by the positive electrode active material 24. On the other hand, the positive electrode active material 24 is reduced by the second redox species 28. The positive electrode active material 24 reduced by the second redox species 28 occludes lithium. For example, these reactions are represented by the following reaction formula. For example, the lithium ions (Li⁺) are supplied from the first liquid 12 through the lithium ion conductive membrane 30.

FePO₄+Li⁺+TTF→LiFePO₄+TTF⁺

Next, the second redox species 28 oxidized by the positive electrode active material 24 is caused to move to the positive electrode 20 by the second circulator 50. The second redox species 28 that has arrived at the positive electrode 20 is reduced again on the surface of the positive electrode 20. For example, this reaction is represented by the following reaction formula.

TTF⁺+e⁻→TTF

In the manner described above, the positive electrode active material 24 is discharged by the circulation of the second redox species 28. That is, the second redox species 28 functions as a discharging mediator.

At the time of the production of the flow battery 100 of the present embodiment, part of the first redox species 18 forms an electrochemically inert compound together with lithium contained in the additional lithium source other than the supporting electrolyte. When the ratio of the inert compound relative to the first redox species reaches a certain value, new inert compound is barely formed from the remaining part of the first redox species 18. That is, the remaining part of the first redox species 18 scarcely forms an inert compound together with lithium during charging of the flow battery 100 and therefore the discharge capacity of the flow battery 100 is hardly lowered. As a result, the flow battery 100 attains high charge/discharge efficiency.

As described hereinabove, the first redox species 18 may have both a function as a charging mediator and a function as a discharging mediator. In this case, the first liquid 12 of the flow battery 100 does not require a compound that functions only as a discharging mediator. Such a flow battery 100 has a simpler configuration than a flow battery that includes a compound functioning only as a discharging mediator. The flow battery 100, however, may include a compound that functions only as a discharging mediator.

In general, the difference between the charging and discharging voltages of a flow battery is affected by the difference between the reduction potential of a charging mediator and the oxidation potential of a discharging mediator. Thus, when the first liquid 12 does not contain a compound functioning only as a discharging mediator, the difference between the charging and discharging voltages of the flow battery 100 is relatively small. In such a case, the flow battery 100 can achieve a reduction in the lowering of power efficiency during charging and discharging. Further, the flow battery 100 has a high energy density when it includes the negative electrode active material 14. By appropriately selecting the first redox species 18 and the negative electrode active material 14, for example, the flow battery 100 can achieve a battery voltage of 3.0 V or above.

### EXAMPLES

The present disclosure will be described in detail based on EXAMPLES. However, the present disclosure is not limited to those EXAMPLES below.

### Measurement Example 1

First, an electrolytic solution on the working electrode side was provided. In this electrolytic solution, 0.1 mol/L biphenyl and 1 mol/L LiPF₆ were dissolved. The solvent of the electrolytic solution was 2-methyltetrahydrofuran (2MeTHF). Next, lithium metal was dissolved into the electrolytic solution. The ratio of the number of moles of lithium metal to the number of moles of biphenyl was 0.52. The electrolytic solution was poured into a working electrode chamber. A cell of MEASUREMENT EXAMPLE 1 was thus fabricated. In the cell of MEASUREMENT EXAMPLE 1, porous stainless steel was used as a working electrode. Lithium ion conductive inorganic solid electrolyte Li₇La₃Zr₂O₁₂ (LLZ) was used as a diaphragm. A 2-methyltetrahydrofuran solution which contained 1 mol/L LiPF₆ dissolved therein and did not contain biphenyl was used as an electrolytic solution on the counter electrode side. Metallic lithium was used as a counter electrode. In the cell of MEASUREMENT EXAMPLE 1, the total of the number of moles M1 of lithium dissolved in the electrolytic solution on the working electrode side and the number of moles M2 of lithium dissolved in the electrolytic solution on the counter electrode side was larger than the number of moles M3 of lithium contained in LiPF₆. In the cell of MEASUREMENT EXAMPLE 1, the value of (M1+M2−M3)/M4 was 0.52 wherein M4 is the number of moles of biphenyl.

Next, the cell of MEASUREMENT EXAMPLE 1 was subjected to charge/discharge measurement. The cell was charged by passing a current of 0.05 mA through the cell for 10 hours. The cell was discharged by taking a current of 0.025 mA out of the cell. The cell was discharged until the cell voltage dropped to 1 V. The charge/discharge efficiency was calculated based on the charge capacity and the discharge capacity obtained by the charge/discharge measurement. The charge/discharge efficiency is the ratio of the discharge capacity to the charge capacity. The initial charge/discharge efficiency of the cell of MEASUREMENT EXAMPLE 1 was 174%.

### Measurement Example 2

A cell of MEASUREMENT EXAMPLE 2 was fabricated in the same manner as in MEASUREMENT EXAMPLE 1, except that the amount of lithium metal dissolved into the electrolytic solution on the working electrode side was changed so that the ratio of the number of moles of lithium metal to the number of moles of biphenyl would be 1.4. In the cell of MEASUREMENT EXAMPLE 2, the total of the number of moles M1 of lithium dissolved in the electrolytic solution on the working electrode side and the number of moles M2 of lithium dissolved in the electrolytic solution on the counter electrode side was larger than the number of moles M3 of lithium contained in LiPF₆. In the cell of MEASUREMENT EXAMPLE 2, the value of (M1+M2−M3)/M4 was 1.4. Next, the cell of MEASUREMENT EXAMPLE 2 was charged and discharged in the same manner as in MEASUREMENT EXAMPLE 1. The initial charge/discharge efficiency of the cell of MEASUREMENT EXAMPLE 2 was 450%.

### Measurement Example 3

A cell of MEASUREMENT EXAMPLE 3 was fabricated in the same manner as in MEASUREMENT EXAMPLE 1, except that the concentration of biphenyl in the electrolytic solution on the working electrode side was changed to 0.015 mol/L and lithium metal was not dissolved in the electrolytic solution on the working electrode side. In the cell of MEASUREMENT EXAMPLE 3, the total of the number of moles M1 of lithium dissolved in the electrolytic solution on the working electrode side and the number of moles M2 of lithium dissolved in the electrolytic solution on the counter electrode side was equal to the number of moles M3 of lithium contained in LiPF₆. In the cell of MEASUREMENT EXAMPLE 3, the value of (M1+M2−M3)/M4 was 0. The cell of MEASUREMENT EXAMPLE 3 was charged and discharged in the same manner as in MEASUREMENT EXAMPLE 1. The Initial Charge/Discharge Efficiency of the Cell of MEASUREMENT EXAMPLE 3 was 12%. Incidentally, the concentration of biphenyl in the electrolytic solution on the working electrode side has little impact on the charge/discharge efficiency of the cell.

TABLE 3

| | Biphenyl | | Initial |
|---|---|---|---|
| | concentration | | charge/discharge |
| | (mol/L) | (M1 + M2 − M3)/M4 | efficiency (%) |
| MEASUREMENT | 0.015 | 0 | 12 |
| EXAMPLE 3 | | | |
| MEASUREMENT | 0.1 | 0.52 | 174 |
| EXAMPLE 1 | | | |
| MEASUREMENT | 0.1 | 1.4 | 450 |
| EXAMPLE 2 | | | |

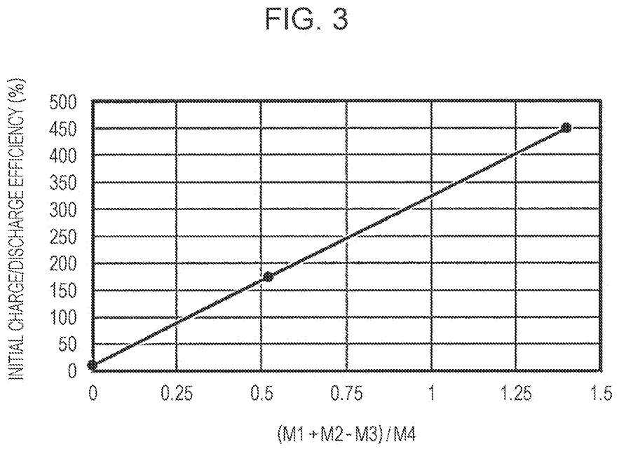

FIG. 3 is a graph illustrating the relationship between the initial charge/discharge efficiency and the value of (M1+M2−M3)/M4 in the cells of MEASUREMENT EXAMPLES 1 to 3. As can be seen from Table 3 and FIG. 3, the cells of MEASUREMENT EXAMPLES 1 and 2 in which the total of the number of moles M1 and the number of moles M2 was larger than the number of moles M3 showed high initial charge/discharge efficiency. This result shows that in the cells of MEASUREMENT EXAMPLES 1 and 2, biphenyl scarcely formed an inert compound together with lithium during charging of the cell. In contrast, the cell of MEASUREMENT EXAMPLE 3 in which the total of the number of moles M1 and the number of moles M2 was equal to the number of moles M3 had an initial charge/discharge efficiency far below 100%. This result shows that in the cell of MEASUREMENT EXAMPLE 3, a large amount of an inert compound containing lithium was formed during charging of the cell.

In the charge/discharge measurement, the cells of MEASUREMENT EXAMPLES 1 to 3 were charged with a constant amount of electricity. Thus, the charge capacities of the cells of MEASUREMENT EXAMPLES 1 to 3 in the charge/discharge measurement were equal to one another. Provided that in the charge/discharge measurement, biphenyl forms almost no inert compound together with lithium during charging of the cell, most of the electricity used for charging is used for discharging. The reasons as to why the initial charge/discharge efficiency exceeded 100% in MEASUREMENT EXAMPLES 1 and 2 are probably as follows. First, in MEASUREMENT EXAMPLES 1 and 2, lithium metal was dissolved into the electrolytic solution at the time of cell production and consequently part of biphenyl formed an electrochemically inert compound together with lithium. Here, an excessive amount of lithium metal was dissolved into the electrolytic solution, and the remaining part of biphenyl and lithium reacted to form Md Li. In MEASUREMENT EXAMPLES 1 and 2, most of the electricity used for charging was used for discharging, and Md.Li formed prior to the charging of the cell was utilized in the discharging reaction, and consequently the discharge capacities of the cells exceeded the charge capacities. These are probably the reasons as to why the initial charge/discharge efficiency exceeded 100% in MEASUREMENT EXAMPLES 1 and 2.

As can be seen from FIG. 3, the configuration of the cells of MEASUREMENT EXAMPLES 1 to 3 offers a larger discharge capacity and higher charge/discharge efficiency with increasing amount of lithium metal dissolved in the electrolytic solution on the working electrode side. In the configuration of the cells of MEASUREMENT EXAMPLES 1 to 3, the initial charge/discharge efficiency of the cell is estimated to be 100% from FIG. 3 when the value of (M1+M2−M3)/M4 is 0.28. From FIG. 3, it is inferred that the initial charge/discharge efficiency of the cell falls below 100% depending on the amount of lithium metal dissolved in the electrolytic solution beforehand.

Evaluation was made as described above in MEASUREMENT EXAMPLES 1 to 3 in order to predict the performance of the flow batteries of the present embodiment. The present inventors have confirmed that the findings obtained based on MEASUREMENT EXAMPLES 1 to 3 can be applied to flow batteries.

The flow batteries of the present disclosure may be used as, for example, power storage devices or power storage systems.

What is claimed is:

1. A flow battery comprising:
a negative electrode;
a positive electrode;
a first liquid in contact with the negative electrode, the first liquid including first redox species that comprises an aromatic compound capable of dissolving lithium as a cation;
a second liquid in contact with the positive electrode; and
a lithium ion conductive membrane disposed between the first liquid and the second liquid, wherein
at least one selected from the group consisting of the first liquid and the second liquid includes a supporting electrolyte including lithium,
the total of the number of moles of lithium dissolved in the first liquid and the number of moles of lithium dissolved in the second liquid is larger than the number of moles of lithium present in the supporting electrolyte, and
the flow battery satisfies 0.2≤(M1+M2−M3)/M4≤1.5 wherein M1 is the number of moles of lithium dissolved in the first liquid, M2 is the number of moles of lithium dissolved in the second liquid, M3 is the number of moles of lithium present in the supporting electrolyte, and M4 is the number of moles of the first redox species.

2. The flow battery according to claim 1, wherein
the flow battery further comprises:
a negative electrode active material in contact with the first liquid;
a first container containing the negative electrode active material; and
a negative electrode chamber containing the negative electrode; and
in the first container, the first redox species is oxidized or reduced by the negative electrode active material.

3. The flow battery according to claim 2, wherein the negative electrode active material includes lithium.

4. The flow battery according to claim 2, further comprising a first circulator that circulates the first liquid between the negative electrode and the negative electrode active material.

5. The flow battery according to claim 1, wherein
the flow battery further comprises:
a positive electrode active material in contact with the second liquid;
a second container containing the positive electrode active material; and
a positive electrode chamber containing the positive electrode;
the second liquid includes second redox species; and
in the second container, the second redox species is oxidized or reduced by the positive electrode active material.

6. The flow battery according to claim 5, wherein the positive electrode active material includes lithium.

7. The flow battery according to claim 5, further comprising a second circulator that circulates the second liquid between the positive electrode and the positive electrode active material.

8. The flow battery according to claim 1, wherein the first redox species comprises at least one selected from the group consisting of phenanthrene, biphenyl, o-terphenyl, triphenylene, anthracene, acenaphthene, acenaphthylene, fluoranthene, trans-stilbene, benzil and naphthalene.

9. The flow battery according to claim 1, wherein the supporting electrolyte comprises LiPF₆.

10. The flow battery according to claim 1, wherein the first liquid includes a cyclic ether as a solvent.

11. The flow battery according to claim 10, wherein the cyclic ether comprises 2-methyltetrahydrofuran.
